(19) United States
(12) Patent Application Publication
(10) Pub. No.: US 2006/0265687 A1
(43) Pub. Date: Nov. 23, 2006

(54) Method for Finding a Function Call Stack in Run Time for a Computer System

(76) Inventor: ANG-SHENG LIN, Chang-Hua Hsien (TW)

Correspondence Address: NORTH AMERICA INTELLECTUAL PROPERTY CORPORATION, P.O. BOX 506, MERRIFIELD, VA, 22116, US

(21) Appl. No.: 11/383,490

(22) Filed: May 16, 2006

(30) Foreign Application Priority Data
May 20, 2005 (TW) 094116506

(51) Int. Cl. G06F 9/44

(52) U.S. Cl. 717/101

(57) ABSTRACT

A method for finding a function call stack when a computer system executes a function in run time includes obtaining a program counter generated from executing the function, obtaining a corresponding instruction according to the program counter, detecting whether the instruction corresponds with a Push-LR-to-Stack instruction, and storing an instruction address pointed to by the program counter when the instruction corresponds with the Push-LR-to-Stack instruction.

### BACKGROUND OF THE INVENTION

1. Field of the Invention

The present invention relates to a method for finding a function call stack when a computer system executes a function in run time, more particularly, a method for finding a function call stack when a computer system executes a function in run time without increasing additional system overhead.

2. Description of the Prior Art

In a computer system, a basic system service is to dynamically allocate a memory block for a function to utilize. When required, each function is able to make a request of the computer system to dynamically allocate the memory block. Later, when the memory block is no longer required by the function, the allocated memory block will be returned to the computer system and this action will achieve the aim of sharing the computer system's memory resources. When a main function begins to execute each thread or process, other sub-functions are called on to execute other tasks according to several factors, such as: input during the allocation, system message, or interrupt of a hard disk. Additionally, the sub-function can call on the other functions according to the program logic; in grouping each function repeatedly the aim of executing a program can be achieved. At every time, that a function call is executed, there is a possibility that any of the factors previously mentioned (e.g., input during the allocation, system message, or interrupt of a hard disk) will exist. Therefore, when a processor of the computer system is executing a function, if the whole function call stack can be obtained, then the computer system can know about the reason and time of the function being called, this information is valuable for problem of tracing and diagnosis when a software is debugging.

Please refer to FIG. 1. FIG. 1 illustrates a functional block diagram of a conventional computer system 10. The computer system 10 includes a microprocessor 12, a flash memory 14, a random access memory (RAM) 16, and a buffer 18. Operation of the computer system 10 is for the microprocessor 12 to access data stored in the flash memory 14, the RAM or the buffer 18, and to execute the necessary calculations. The flash memory 14 is a non-volatile memory for storing source code FS1 of a first function F1, source code FS2 of a second function F2, and two corresponding pre-process directives of the first function F1, “_{——}FILE_{——}” and “_{——}LINE_{——}” respectively. The purpose of these pre-process directives will be explained later. The RAM 16 is a volatile memory that includes a plurality of memory blocks 16a, 16b, and 16c whereas the memory block 16a has a head 16ah, the memory block 16b has a head 16bh, and the memory block 16c has a head 16c. Furthermore, in the computer system 10, the buffer 18 is utilized for storing execution code generated after the microprocessor 12 compiles a function.

Please refer to FIG. 1 and FIG. 2 simultaneously. FIG. 2 illustrates a diagram of a first function F1 calling a second function F2. When the microprocessor 12 compiles a program comprising a first function F1 and a second function F2, it can be known that in the first function F1, content of a line L1 of executable code is calling for the second function F2 in the compile time, at this time, according to the prior art, the microprocessor 12 will record the function name (e.g., such as F1) of the first function F1 into the pre-process directive _{——}FILE_{——}, and the line L1 will be recorded into the pre-process directive _{——}LINE_{——}. After the program compilation has completed, the microprocessor 12 will generate a function execution code FE1 corresponding to the first function F1 and a function execution code FE2 corresponding to the second function F2, the function execution code FE1 and the function execution code FE2 will be stored into the buffer 18.

In this embodiment, the aim of the first function F1 calling the second function F2 is to request the computer system 10 to allocate a memory block to the first function F1, therefore after the program compilation has completed, when the computer system executes the contents of the first function execution code FE1, to obtain part of the corresponding line L1 during run time, the run time will branch to the address of the second function execution code FE2. This means that the contents of the second function execution code FE2 is executed from the second function F2's starting point, if the current computer system 10 accepts a request from the first function F1 to allocate the memory block to be utilized by the first function F1 to be the memory block 16b, at this time, the computer system 10 records the memory allocation information into the header of the memory block 16b which means that the content recorded by the pre-process directives _{——}FILE_{——} and _{——}LINE_{——} are the function name (F1) of the first function F1 and the line L1 respectively and to be copied to the header of the memory block 16b. Those skilled in the art will know that data type of the pre-process directive _{——}FILE_{——} is a character, therefore if the longer the function name required to be stored, the greater the storage space taken up by the pre-process directive _{——}FILE_{——}, and the data type of the line stored the pre-process directive _{——}FILE_{——}is an integer, usually the space taken up by the integer is 4 bytes. After the computer system 10 executes the second function execution code FE2, the run time will branch back to the first function F1 and will continue to execute a line L2 of the first function F1 (i.e., a line below the line L1), which also means part of the line L2 corresponding to the first function execution code FE1 is executed.

In the above-mentioned, a programmer can know that the memory block 16b is the memory block allocated to the first function F1 by the computer system 10, by checking the header of the memory block 16b. Therefore, in utilizing the conventional method, the programmer is able to know the allocations of the memory blocks, and to view which memory block is allocated to which function request by the computer system 10 to find out what problem occurred that may have caused the computer system to crash or for a computer program error to be generated. However, the conventional method in the program compiler requires that space from the non-volatile memory is utilized for recording the memory allocation information. This memory allocation information is the content of the pre-process directives: _{——}FILE_{——} and _{——}LINE_{——}. Later during the run time, the memory allocation information is copied into the RAM. This process increases the time utilizing and the cost of the memory space in the computer system and results in an increased system overhead as well. Therefore, the method of analyzing system crashes and programming errors is not efficient.

### SUMMARY OF THE INVENTION

The claimed invention provides a method for finding a function call stack while not increasing additional system overhead when a computer system executes a function in run time to solve the above-mentioned problem.

One embodiment of the claimed invention discloses a method for finding a function call stack when a computer system executes a function in run time. The method comprises obtaining a program counter generated from executing the function, obtaining a corresponding instruction according to the program counter, detecting whether the instruction corresponds with a Push-LR-to-Stack instruction, and storing an instruction address pointed to by the program counter when the instruction corresponds with the Push-LR-to-Stack instruction.

Another embodiment of the claimed invention discloses a method of finding a function call stack when a computer system executes a function in run time. The method comprises obtaining a program counter and a stack pointer generated from executing the function, obtaining a corresponding instruction according to the program counter, detecting whether the instruction corresponds with a Push-LR-to-Stack instruction, setting the program counter to point to a previous instruction when the instruction does not correspond with the Push-LR-to-Stack instruction, detecting whether the previous instruction corresponds with the Push-LR-to-Stack instruction, and storing an instruction address pointed to by the program counter when the previous instruction corresponds with the Push-LR-to-Stack instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a conventional computer system.

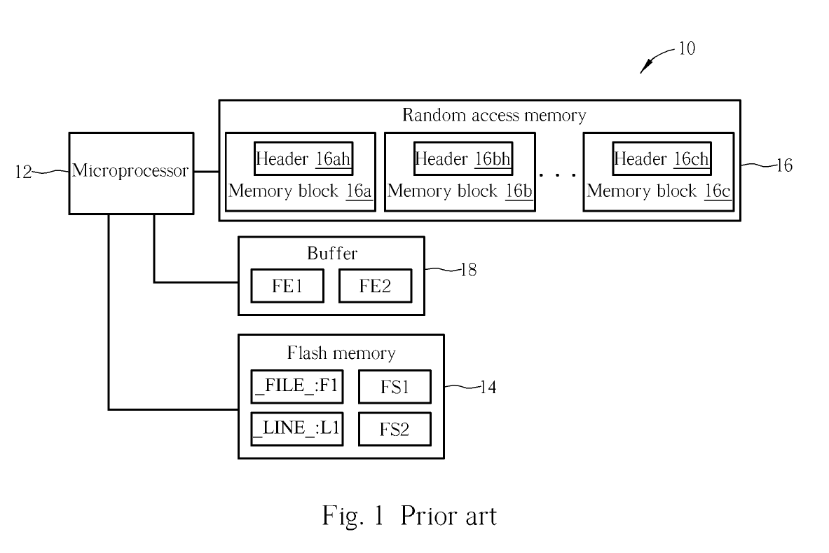

FIG. 2 illustrates a diagram of a first function calling a second function.

FIG. 3 illustrates a flowchart of finding a function call stack when a computer system executes a function in run time according to the present invention.

### DETAILED DESCRIPTION

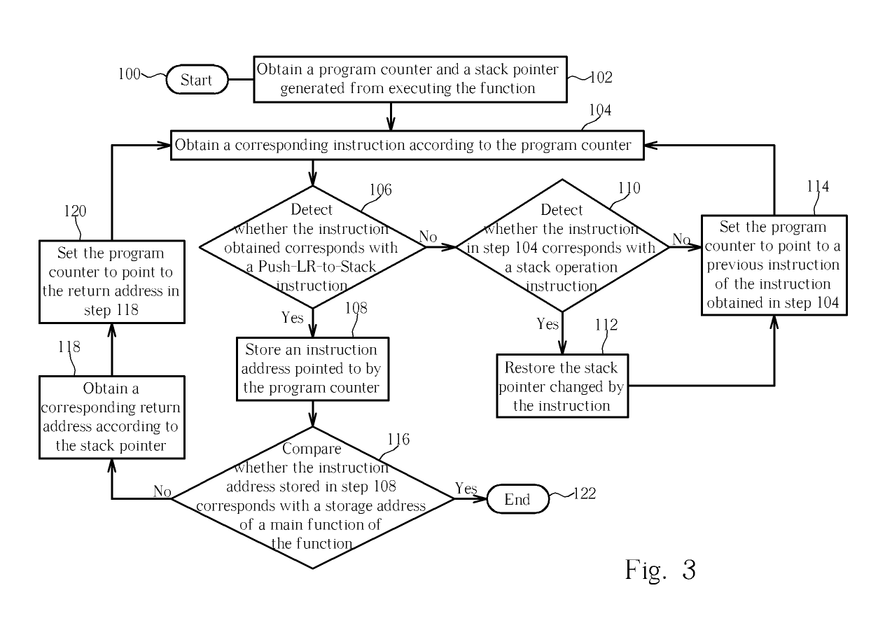

Please refer to FIG. 3. FIG. 3 illustrates a flowchart of finding a function call stack when a computer system executes a function in run time according to the present invention.

The method includes the following steps:

Step 100: start;

Step 102: obtain a program counter and a stack pointer generated from executing the function;

Step 104: obtain a corresponding instruction according to the program counter;

Step 106: detect whether the instruction obtained corresponds with a Push-LR-to-Stack instruction; if so execute step 108; if not execute step 110;

Step 108: store an instruction address pointed to by the program counter and go to step 116;

Step 110: detect whether the instruction in step 104 corresponds with a stack operation instruction; if so execute step 112; if not execute step 114;

Step 112: restore the stack pointer that was changed by the instruction in step 104 and then go to step 114;

Step 114: set the program counter to point to a previous instruction of the instruction obtained in step 104, and execute step 104 again;

Step 116: compare whether the instruction address stored in step 108 corresponds with a storage address of a main function of the function; if so execute step 122; if not execute step 118;

Step 118: obtain a corresponding return address according to the stack pointer;

Step 120: set the program counter to point to the return address in step 118, and execute step 104 again;

Step 122: end.

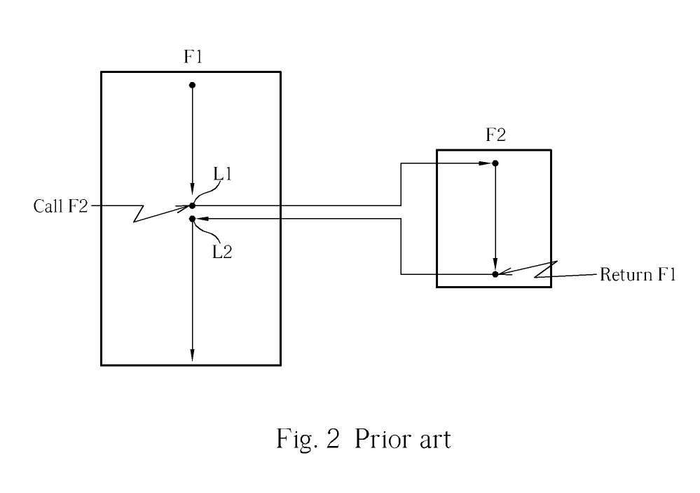

The above-mentioned steps will now be explained in further detail. The program counter and the stack pointer, generated when the function is executed, can be obtained by several methods, for example: the program counter and the stack pointer can be obtained by reading a program counter register and a stack pointer register when the system crashes; or the program counter and the stack pointer can be obtained from a program counter buffer value and a stack pointer buffer value stored in the stack when the computer system executes a line change; or when FIG. 2 of the prior art utilizes the first function F1 to call on the second function F2, the second function F2 obtains a return position from the first function F1. In regards to this last method for generating the program counter and the stack pointer, an instant program counter value can be obtained after the first function F1 calls on the second function F2, and a region variable address of the second function F2 is a stack pointer value, a compiled file of the second function F2 can be checked to determine how much offset is required for the stack pointer to become the region variable after entering the second function F2, and the stack pointer is obtained after the first function F1 has been called.

Next, a value-obtain action is performed to obtain the corresponding instruction according to the program counter. The instruction is then compared with the instruction of storing a return address in an LR register into the stack according to the instruction code. The instruction of storing a return address in an LR register into the stack is a first instruction of a function that is making a function call (i.e., the originating calling function rather than the called function) according compiler theory when a compiler is processing a nested function (e.g., a recursive function). Additionally, only a very small variation of the compiled file, when compiled utilizing a different compiler, will require corrections. When the instruction in step 104 corresponds to the Push-LR-to-Stack instruction it means that the current program counter is pointing to the starting point of the function. At this time the instruction address pointed to by the program counter is stored, therefore, the memory address corresponding to the function can be stored. If the instruction in step 104 does not correspond to the Push-LR-to-Stack instruction, then next the instruction in step 104 will be compared with a stack operation instruction, if the instruction in step 104 is related, then the stack pointer change is restored by the instruction in step 104. For example, if the offset of the instruction and the stack pointer is +8, in order to restore the effect of the instruction and the stack pointer, an action of offset −8 is applied to the stack pointer. The program counter is then set to point to a previous instruction of the instruction obtained in step 104, the updated program counter will be utilized to execute step 104 again which means that the current program counter subtracts an instruction value according to the length of the instruction. For example, if the instruction is 32 bit, the current program counter will be decremented by 4, if the instruction is 16 bit, the current program counter will be decremented by 2, and so forth. If the instruction of step 104 and the stack operation instruction are not related, then the program counter is set to point to a previous instruction of the instruction obtained in step 104 and the updated program counter will be utilized to execute step 104 again.

When the instruction in step 104 corresponds to the Push-LR-to-Stack instruction and also the instruction address pointed to by the program counter is being stored, then the instruction address in step 108 is being compared with a storage address of a main function name of the function and whether the instruction address in step 108 corresponds to the storage address of the main function name of the function (i.e., which means is the instruction address pointed by the current program counter corresponding to the storage address of the main function name). If they correspond, it means that the addresses of all the function call stack of the main function have been obtained, hence the flowchart can be completed. If the instruction address in step 108 does not correspond to the storage address of the main function name of the function then this means that not all of the addresses of the function call stack of the main function are being obtained. At this time the action of jumping back to an upper level of the current function is executed in an attempt to obtain the function call stack until a thread main function at the beginning (i.e., top) is reached to obtain the address of all of the function call stacks of the main function. The execution process is a restoring action according to the operation of the Push-LR-to-Stack instruction on the stack pointer, and the restored stack pointer then obtains a return location that was stored in the return register. The restoring action in general means that after the Push-LR-to-Stack instruction stores the return location that was stored in the return register back into the stack, usually other registers will still be accessed, therefore there is a need to restore the stack pointer change according to other registers accessed outside of the stack. In this way the value of the function call return address can be accurately obtained from the memory of the stack. Furthermore, if the stack is formed by a non-continuous stack frame then there is a need to search for a next stack frame according to the data structure. Lastly, the program counter is set to point to the return location obtained by the restored stack pointer. This action also represents a call process of the current function jumping to an upper level function and then the recursion calculation begins again.

The address of all of the function call stacks of the main function are being obtained to determine the function instruction corresponding to the instruction address pointed to by the program counter according to a linker map, in another words, the function names representing each function address can be searched. In this way, when history routes of each of the function call stacks are needed each of the functions can be located during the execution of a thread or a process.

In comparison to the method of the prior art, when needed, the method of the present invention is capable of finding a function call stack or corresponding function name when a computer system executes a function in run time without increasing system overhead, when not needed, there is no increase in system overhead at all. In defining the function call stack it helps to analyze the last execution status of executing a thread when the computer system crashes, hence this provides an effective method of analyzing a system crash or program error.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for finding a function call stack when a computer system executes a function in run time, the method comprising the following:
(a) obtaining a program counter generated from executing the function;
(b) obtaining a corresponding instruction according to the program counter;
(c) detecting whether the instruction in step (b) corresponds with a Push-LR-to-Stack instruction; and
(d) storing an instruction address pointed to by the program counter when the instruction in step (b) corresponds with the Push-LR-to-Stack instruction.

2. The method of claim 1, further comprising the following:
(e) obtaining a stack pointer generated from executing the function;
(f) comparing the instruction address stored in step (d) with a storage address of a main function name of the function;
(g) obtaining a corresponding return address according to the stack pointer when the instruction stored in step (d) does not correspond with the storage address of the main function name; and
(h) setting the program counter to point to the return address in step (g).

3. The method of claim 1, wherein the method in step (a) further comprises obtaining the program counter from a program counter buffer of the computer system when the computer system crashes in step (a).

4. The method of claim 1, wherein the method in step (a) further comprises obtaining the program counter from a program counter buffer value stored in a stack when the computer system executes a line change.

5. The method of claim 1, further comprising determining a function instruction corresponding to the instruction address pointed to by the program counter stored in step (d) according to a linker map.

6. A method of finding a function call stack when a computer system executes a function in run time, the method comprising the following:
(a) obtaining a program counter and a stack pointer generated from executing the function;
(b) obtaining a corresponding instruction according to the program counter;
(c) detecting whether the instruction obtained in step (b) corresponds with a Push-LR-to-Stack instruction;
(d) setting the program counter to point to a previous instruction of the instruction obtained in step (b) when the instruction in step (b) does not correspond with the Push-LR-to-Stack instruction;
(e) detecting whether the previous instruction obtained in step (d) corresponds with the Push-LR-to-Stack instruction; and
(f) storing an instruction address pointed to by the program counter in step (d) when the previous instruction in step (d) corresponds with the Push-LR-to-Stack instruction.

7. The method of claim 6, further comprising the following:
(g) detecting whether the instruction in step (b) corresponds with a stack operation instruction when the instruction in step (b) does not correspond with the Push-LR-to-Stack instruction; and
(h) restoring the stack pointer changed by the instruction in step (b) when the instruction in step (b) corresponds with the stack operation instruction.

8. The method of claim 6, further comprising the following:
(i) comparing the instruction address stored in step (d) with a storage address of a main function name of the function;
(j) obtaining a corresponding return address according to the stack pointer when the instruction address in step (f) does not correspond with the storage address of the main function name; and
(k) resetting the program counter in step (d) to point to the return address in step (j).

9. The method of claim 6, wherein the method in step (a) further comprises obtaining the program counter from a program counter buffer of the computer system when the computer system crashes.

10. The method of claim 6, wherein the method in step (a) further comprises obtaining the program counter from a program counter buffer value stored in a stack when the computer system executes a line change.

11. The method of claim 6, further comprising determining a function instruction corresponding to the instruction address pointed to by the program counter stored in step (f) according to a linker map.
